(19) United States
(12) Patent Application Publication
(10) Pub. No.: US 2006/0066093 A1
(43) Pub. Date: Mar. 30, 2006

(54) Creative quietbook

(75) Inventors: Susan G. Healton, Kokomo, IN (US); Tamara Lynn Keller, Woodridge, IL (US)

Correspondence Address: Frank D. Lachenmaier;Suite 200, 116 N. Main St., P.O. Box 1047, Kokomo, IN, 46903-1047, US

(73) Assignee: Memories For Always, Kokomo, IN (US)

(21) Appl. No.: 11/080,174

(22) Filed: Mar. 15, 2005

Related U.S. Application Data
(60) Provisional application No. 60/613,074, filed on Sep. 24, 2004.

(51) Int. Cl. B42D 1/00

(52) U.S. Cl. 281/21.1

(57) ABSTRACT

This invention relates generally to a flexible photo album where the photos are printed on fabric pages and the pages bound together. More specifically, this invention relates to a unique method of collecting and arranging photographs, text and associated artwork digitally and printing that arrangement on a foldable page pair. The page pairs are cut from a soft flexible material and placed back to back with quilt batting between them, coupled together with serge type stitching around the perimeter of said page pair. Page pairs are stacked on the cover-back pair and the spine of the album is sewn in the middle and the page pairs are folded over at the spine forming the Quietbook.

### BACKGROUND

1. Field of Invention

This invention relates generally to a unique photo album designed for infants and toddlers whereby all of the photos, artwork and text selected by the consumer are printed on soft fabric pages, cover and back and a method of producing same. Although this invention was originally targeted at infants it has found wide acceptance by others such as college students away from home and other standard photo album uses.

2. Prior Art

A variety of photo albums are available on the market. U.S. Pat. No. 6,061,943 Pepys 2000 discloses a photo album for an infant which has flexible front and back covers and a tie with which it can be secured to a crib or playpen side rail. It uses transparent sheets held together by a fabric seam for photo retaining internal pages. This album patent discloses none of the printing and labeling on cloth features that the Quietbook embodies and still uses photos on typical photographic paper that an infant might pull from the plastic pocket and injure herself on their sharp edges.

U.S. Pat. No. 6,623,528 Squilla 2003 shows a method of constructing a photo collage or album based on converting a customer's photos to digital thumbnail images and allowing the customer to select which ones he wants to include and then constructing a photo album from the digital images represented by the selected thumbnails. No mention of anything other than standard photo processing or digital Image file generation is found here.

U.S. Pat. No. 6,324,545 Morag 2001 shows a method of generating an album with a plurality of digitally encoded images automatically arranged to fit a format of an album and printing same using the predetermined arrangement. Preferably here each page is a single sheet of photographic paper. This patent again has no provisions for printing photos on cloth in two up pages with other text and graphics or construction of the physical album.

U.S. Pat. No. 6,314,585 Mann 2001 shows a process for adding printed images to raw fabric before cutting the fabric into garment pieces, such that each image is positioned at a selected position on the garment. A marker is created containing a sight point and an identification of the bounds of at least some pieces of a garment. A sight point is printed on the fabric and an image printed relative to that sight point that is the same as the relation of the position and orientation of the image to the sight point on the marker. Pieces are then cut and assembled into the garment. The Quietbook again accomplishes a similar end result by placing photographic images for printing on precut sheets of fabric, the size and shape of album desired, but with a dramatically different method.

### SUMMARY

An object of the present invention is to provide a customized photo album with the photos and associated text and artwork printed on fabric pages with no hard surfaces or sharp edges that could be harmful to an infant. Another object of the present invention is to provide a customized photo album where photos, text and artwork are arranged digitally and color can be digitally enhanced prior to printing on fabric or other suitable medium.

A further object is to provide a customized photo album that contains a small non-breakable mirror embedded in the first page so that the infant not only sees pictures of his family but also can watch himself change as he matures.

A further object is to provide a customized photo album for graduation or a “leaving-the-nest” gift that will survive moving, packing or other less than careful handling.

### DRAWINGS

In order that the invention may be more fully understood it will now be described by way of example, with reference to the accompanying exemplary drawings in which:

FIG. 1 is a perspective view of a partially open Quietbook.

FIG. 2 is a flow chart of the construction process or method.

FIG. 3 is a block diagram of the system used to produce quiet books.

FIG. 4 is a top view of the cloth or other medium sized to fit the color printer.

FIG. 5 is a top view of the cloth or other medium after printing the page pairs.

FIG. 6 is a top view of a page pair after it has been sheared from the printed cloth or other medium.

FIG. 6A is shows an optional embodiment where a mirror is encased on the inside of the first page of a Quietbook.

FIG. 7 is a top view a rectangular sheet of quilt batting sized slightly smaller than the page pairs.

FIG. 8 is a an exploded view showing a printed page face down, a quilt batting sheet laid on top of it and another page pair laid on top of the quilt batting sheet with the printed side up.

FIG. 9 is a perspective view looking at a partially open Quietbook from the back showing the serge stitching holding the page pairs and their quilt batting together and the spine or binding stitching holding the assembled page pairs together in book form.

### REFERENCE NUMERALS

The same reference numbers are used to refer to the same or similar parts in the various views. 10—Quietbook 12—photo 14—text medium 16—art work 18—front cover 20—back cover 22—spine 24—serge stitch 26—digital camera 28—scanner 30—personal computer 32—color printer 34—cloth shear 36—cloth or other printable 38—printed cloth 40—printed page pair 42—quilt batting 44—printed page pair sandwich 46—page pair binding line 48—optional mirror 50—space for advertisement 52—sewing machine

### DESCRIPTION

The present invention, in its several embodiments, meets the above mentioned objectives.

An object of the present invention is to provide a customized Quietbook 10 with photos 12, associated text 14 and artwork 16 printed on fabric pages with no hard surfaces or sharp edges that could be harmful to an infant. This is accomplished by printing photos 12, associated artwork 16 and text 14 on fabric pages and sewing the pages together with a quilt batting between the pages.

Another object of the present invention is to provide a customized photo album where photos 12, text 14 and artwork 16 are arranged digitally and color can be digitally enhanced prior to printing on cloth 36 or other suitable medium. Standard digital data management systems such as the Adobe® Graphics Suite can be used for this arranging step.

A further object is to provide a customized Quietbook 10 that contains a small non-breakable mirror 48 embedded in the first page so that the infant not only sees pictures of his family but also can watch herself change as she matures. Use of a reflective treated plastic surface that can be embedded in the first page of Quietbook 10 provides a safe mirror 48 that an infant can enjoy without danger.

A further object is to provide a customized Quietbook 10 album for graduation or a “leaving-the-nest” gift that will survive moving, packing or other less than careful handling.

Operation:

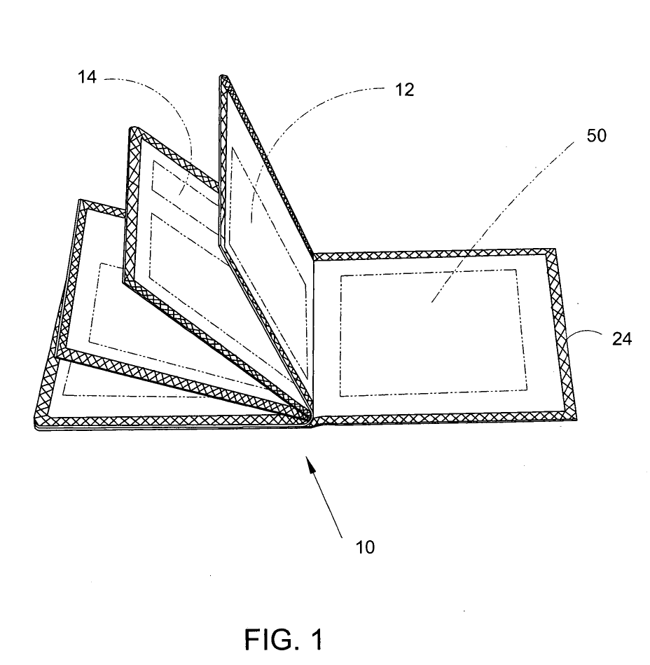

FIG. 1 shows a perspective view of a partially open Quietbook 10 disclosing the inside of the back page with an area shown in phantom lines where advertisement 50 could be printed and on the preceding pages areas where photos 12 and text 14 can be printed.

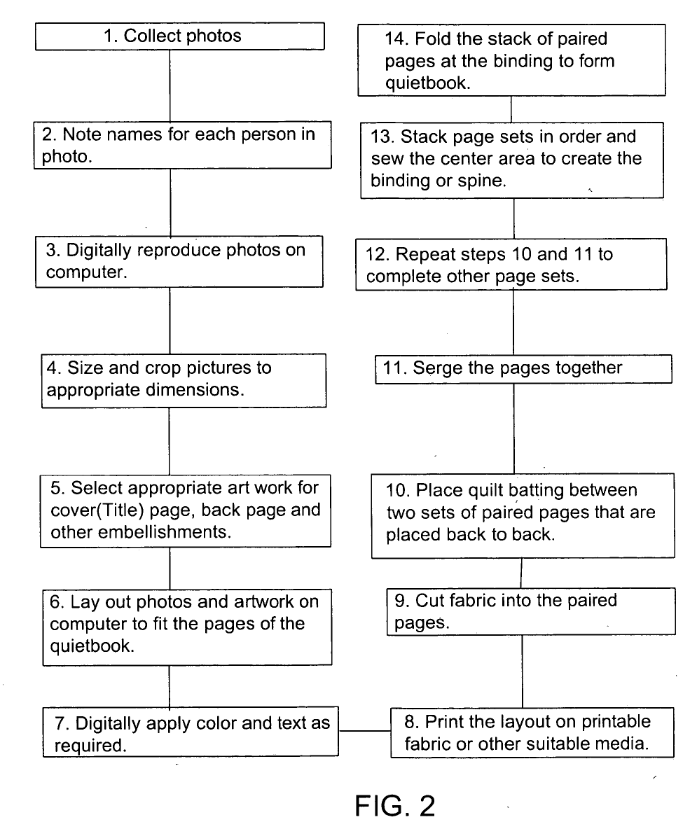

FIG. 2 shows a flow chart for the 14 step process of collecting, digitizing, arranging, cutting, printing pre-selected photos, text and artwork onto page pairs and sewing them into a customized Quietbook 10 on a soft and infant friendly medium.

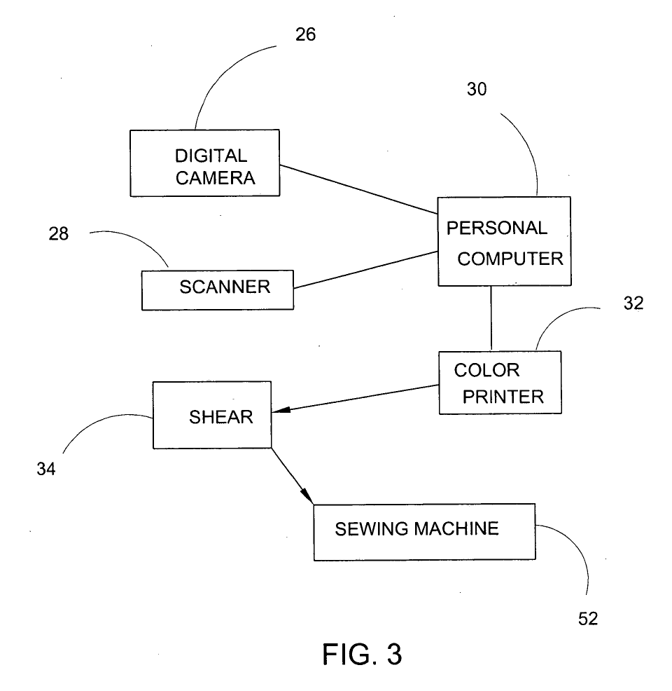

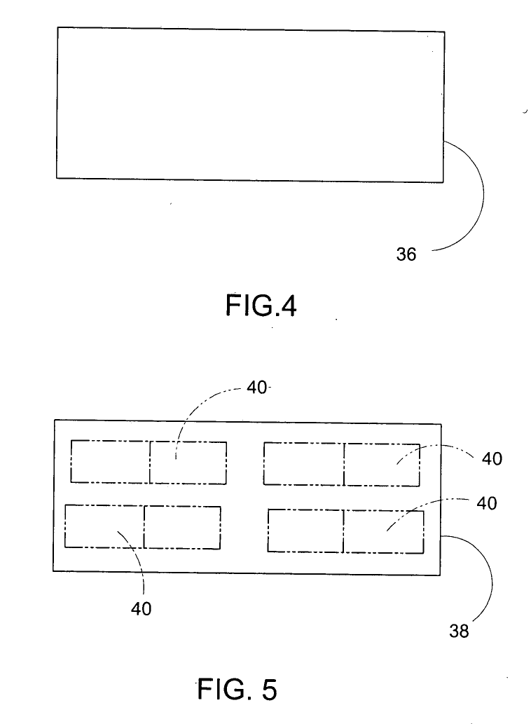

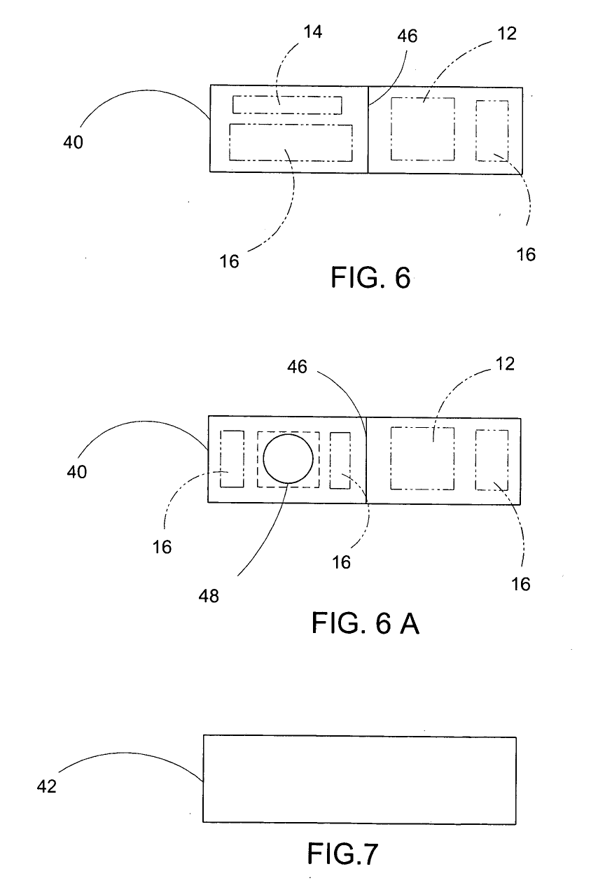

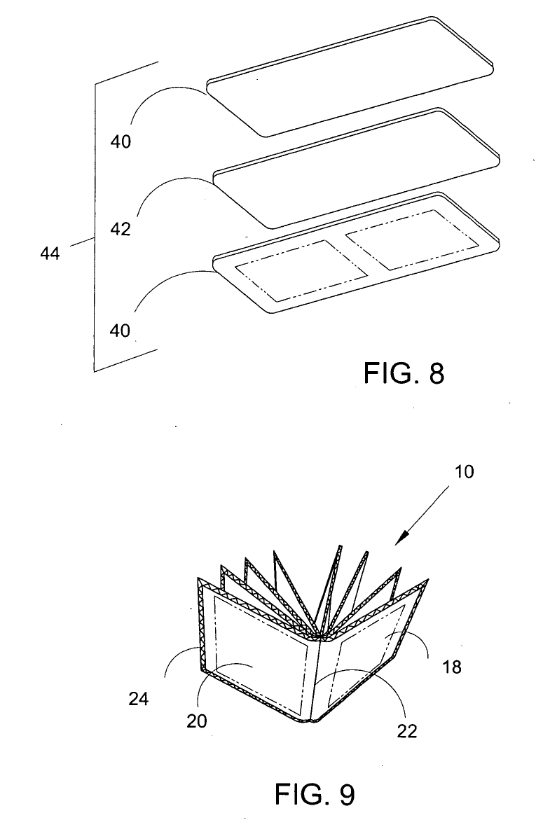

FIG. 3 shows a block diagram of the system used in the preferred embodiment where photos 12 can either be downloaded from digital camera 26 into personal computer 30 or input by utilizing scanner 28. Standard digital data management systems such as the Adobe® Graphics Suite can then be used to crop photos 12 to the appropriate size, integrating them with appropriate text 14 and artwork 16. Colors can be digitally enhanced and then the digital data fed to color printer 32 that has been loaded with appropriate size cloth sheet 36 shown in FIG. 4 or other suitable printing medium. When the full sheet of printed cloth 38 has finished the printing step shown in FIG. 5, it is sheared into the individual printed page pairs 40 as shown in FIGS. 6 and 6A. The front cover 18 and back cover 20 page pair is placed printed side down and quilt batting sheet 42, shown in FIG. 7, laid on top of it. The inside of the front page and back page pair is then laid on top of quilt batting sheet 42 with the printed side up. This page pair sandwich 44 as shown in FIG. 8 is then processed through sewing machine 52 using a serge stitch completely around the perimeter of the page pairs 40 to couple the page pair sandwich 44 together securely. This step is repeated until all the page pair sandwiches 44 have been assembled. All the page pair sandwiches 44 are then stacked and a seam 22 is sewn along the binder line 46 in the center of the page pairs shown in FIG. 9. Quietbook 10 is then folded at the spine line 22 in book form.

What is claimed is:

1. An album for an infant comprising:
a plurality of generally rectangular sheets of a soft flexible material with a front side and a back side, with preselected art work, text and photographs printed on said front side of the material;
a plurality of page pairs assembled by placing a selected two of said rectangular sheets of said soft flexible material back to back, coupled together with serge type stitching around the perimeter of said page pair with a sheet of batting material in between said rectangular sheets,
a stack of said assembled page pairs beginning with said front and back cover page pair and topping off with the center of the book page pair connected at the center of the page pairs by a spine stitch from the top through the bottom of said stack and folding the page pair stack at the spine line forming the book.

2. The album of claim 1 wherein the inside of the front cover has a flexible mirror embedded in the center of the page.

3. The album of claim 1 wherein the pages are made from material treated to make it stain resistant and the printing inks water proof.

4. The album of claim 1 wherein the pages are printed on media selected from a group consisting of cloth, paper, plastic and cardboard.

5. The album of claim 1 for an adult or teenager as a going away memory book.

6. A method of generating a photographic album, comprising:
collecting the set of photographs from the customer that she wants included in said album;
noting the names of each person in said photographs for later use as descriptive text;
reproducing digitally said photographs on personal computer from either a scanner or digital camera;
sizing and cropping photographs to appropriate dimensions;
selecting appropriate art work for front and back covers, title page and other internal embellishments;
laying out photographs, artwork and text to fit selected page size for album;
applying color digitally and text as required;
printing layout on front side of fabric or other media;
cutting fabric into paired pages;
placing batting material between two printed page pairs that are placed back to back;
sewing said page pairs and batting sandwich together with a serge stitch around the perimeter of said page pair;
repeating the sewing step on each of the page pair sandwiches;
stacking page pair sandwiches in appropriate order;
sewing the center line in the middle of the page pair to create a binding or spine; and
folding the stack of paired page sandwiches at the binding producing a Quietbook form.

7. The method of generating a photographic album of claim 6 wherein embedding an unbreakable mirror in the inside of said front cover allows an infant to watch herself as she grows.

8. The method of generating a photographic album of claim 6 by printing the pages on media selected from a group consisting of cloth, paper, plastic and cardboard.
